(19) United States
(12) Patent Application Publication
(10) Pub. No.: US 2009/0204817 A1
(43) Pub. Date: Aug. 13, 2009

(54) COMMUNICATION SYSTEM

(75) Inventors: Derek G. Deana-Roga, Skillman, NJ (US); Till Immanuel Patzschke, Dubai (AE)

Correspondence Address: SONNENSCHEIN NATH & ROSENTHAL LLP, P.O. BOX 061080, WACKER DRIVE STATION, SEARS TOWER, CHICAGO, IL, 60606-1080, US

(73) Assignee: OCI Mobile LLC, Dubai (AE)

(21) Appl. No.: 12/210,736

(22) Filed: Sep. 15, 2008

Related U.S. Application Data
(60) Provisional application No. 60/973,065, filed on Sep. 17, 2007.
(60) Provisional application No. 61/077,858, filed on Jul. 2, 2008.

(51) Int. Cl. H04L 29/06; G06F 17/30; H04L 9/32

(52) U.S. Cl. 713/171; 713/150; 707/200; 707/E17.044

(57) ABSTRACT

In a method and system for a communications system, identifying at least one of a received message that has been decrypted using a first decryption method and a message to be sent that is to be encrypted using a first encryption method, generating a copy of the at least one of the received message and the message to be sent, encrypting the copy of the at least one of the received message and the message to be sent using a second encryption method to create an encrypted copy of the at least one of the received message and the message to be sent, and transmitting the encrypted copy of the at least one of the received message and the message to be sent from the communications device for decryption and storage.

### CROSS REFERENCE TO RELATED APPLICATIONS

The present application claims priority to U.S. Provisional Application Ser. No. 61/077,858, filed Jul. 2, 2008, and U.S. Provisional Application Ser. No. 60/973,065, filed Sep. 17, 2007; each of which is incorporated herein by reference in its entirety.

### BACKGROUND

Globally there is an increasing need for mobile users to access e-mail services anytime and anywhere. In 2006, there were around 1.45 billion e-mail accounts, consisting of enterprise and consumer inboxes. From a law enforcement perspective these trends pose a dilemma: on the one hand they want to ensure that enterprises and consumers keep the latest communication technology abreast in order to become more efficient and personally benefit from these new features whereas on the other hand it poses potential security threats if this communication cannot be tracked. The major challenge to law enforcement agencies as more and more communication is based on different types of electronic messaging is to intercept electronic communication in a lawful though simple and straightforward way. By doing so they ensure the safety and stability of their country from potential criminal acts and security threats.

Whereas e-mail and text messaging are text-based and run through an open and accessible nexus, peer-to-peer messaging and special hardware solutions open a serious gap in the lawful interception of communication.

Contrary to communication through public infrastructure, more and more of the popular mobile devices use privately run infrastructure or peer-to-peer structures for e-communication apart from e-mail, most notably Instant Messaging (IM). Today more than 100,000 enterprises use a portable e-mail device such as the BlackBerry Solution provided by Research in Motion.

This opens a need for a simple to install and maintain LIC (lawful interception of communication) system, especially targeted at mobile communications devices.

### SUMMARY

A method and system for a communication system is disclosed. An embodiment is disclosed that receives a request to route an encrypted message for a communications device and the encrypted message has been encrypted using a first encryption method, decrypts the encrypted message using a first decryption method to create a decrypted message, re-encrypts the decrypted message using a second encryption method to create a re-encrypted message, transmits the re-encrypted message, decrypts the re-encrypted message using a second decryption method to create a decrypted re-encrypted message, and stores the decrypted re-encrypted message.

Another embodiment is disclosed that receives an encrypted message at a communications device, decrypts the encrypted message using a first decryption method to create a decrypted message, re-encrypts the decrypted message using a second encryption method to create a re-encrypted message, and sends the re-encrypted message for decryption and storage.

Another embodiment is disclosed that maintains an interaction log for a communications device which records interactions within the communication system, encrypts the interaction log using an encryption method to create an encrypted interaction log, transmits the encrypted interaction log to a repository, decrypts the encrypted interaction log at the repository using a decryption method to create a decrypted interaction log, and stores the decrypted interaction log in the repository.

Another embodiment is disclosed that sends a request to route a message from a communications device, accesses the message prior to encryption using a first encryption method, generates a copy of the message, encrypts the copy of the message using a second encryption method to create an encrypted copy of the message, and transmits the encrypted copy of the message from the communications device for decryption and storage.

Another embodiment is disclosed that identifies at least one of a received message that has been decrypted using a first decryption method and a message to be sent that is to be encrypted using a first encryption method, encrypts the at least one of the received message and the message to be sent using a second encryption method to create an encrypted at least one of the received message and the message to be sent, and transmits the encrypted at least one of the received message and the message to be sent from the communications device for decryption and storage.

Another embodiment is disclosed that identifies at least one of a received message that has been decrypted using a first decryption method and a message to be sent that is to be encrypted using a first encryption method, generates a copy of the at least one of the received message and the message to be sent, encrypts the copy of the at least one of the received message and the message to be sent using a second encryption method to create an encrypted copy of the at least one of the received message and the message to be sent, and transmits the encrypted copy of the at least one of the received message and the message to be sent from the communications device for decryption and storage.

Another embodiment is disclosed that identifies at least one of a received message that has been decrypted using a first decryption method and a message to be sent that has been encrypted using a first encryption method, re-encrypts the at least one of the received message and the message to be sent using a second encryption method to create a twice encrypted at least one of the received message and the message to be sent, and transmits the twice encrypted at least one of the received message and the message to be sent from the communications device for decryption and storage.

Another embodiment is disclosed that is a computer readable medium operable to store a set of instructions that are configured to identify at least one of a received message that has been encrypted using a first decryption method and a message to be sent that has been encrypted using a first encryption method, encrypt the at least one of the received message and the message to be sent using a second encryption method to create an encrypted copy of the at least one of the received message and the message to be sent, and transmit the encrypted at least one of the received message and the message to be sent from the communications device for decryption and storage.

Another embodiment is disclosed that has a server to service requests to route an encrypted message for a communications device and the encrypted message has been encrypted using a first encryption method, and a computer readable medium operable to store a set of instructions that are configured to decrypt the encrypted message using a first decryption method to create a decrypted message, re-encrypt the decrypted message using a second encryption method to create a re-encrypted message, transmit the re-encrypted message, decrypt the re-encrypted message using a second decryption method to create a decrypted re-encrypted message, and store the decrypted re-encrypted message.

For each of the disclosed embodiments, one or more of the following features or combinations of features may apply: copying a decrypted message from a memory stack before re-encrypting the decrypted message using a second encryption method, copying at least one of the received message and the message to be sent from a memory stack in the communications device, storing a message in a repository, a repository that provides for a third party to monitor messages sent by a communications device, a repository that provides for a third party to monitor messages received by a communications device, an encrypted message that is an e-mail message and/or an instant message, recording location information in a repository, a repository that filters messages, a repository that filters messages by a keyword, a repository that filters messages and stores the messages in the repository by a date, storing location information that is a geographical position of a communications device receiving an encrypted message, monitoring interactions with a communications device by a user, monitoring interactions of a communications device within a communication system, storing interactions of a communications device in an interaction log, transmitting interception software to a communications device, transmitting interception software to a communications device upon entry of the communications device into a network, receiving an encryption key from a communications device, transmitting an encryption key to a repository, transmitting a re-encrypted message to a repository using a first communication channel and transmitting information on interactions to the repository using a second communication channel.

### BRIEF DESCRIPTION OF THE DRAWINGS

FIG. 1 depicts an embodiment of a communication system according to the present application.

FIG. 2 depicts another embodiment of a communication system according to the present application.

FIG. 3 depicts another embodiment of a communication system according to the present application.

FIG. 4 depicts a flow diagram of a method according to the present application.

FIG. 5 depicts a flow diagram of a method according to the present application.

FIG. 6 depicts an alternative embodiment of a communication system according to the present application.

FIG. 7 depicts an alternative embodiment of a communication system according to the present application.

FIG. 8 depicts an alternative one embodiment of a communication system according to the present application.

FIG. 9 depicts an alternative embodiment of a communication system according to the present application.

FIG. 10 depicts an alternative embodiment of a communication system according to the present application.

FIG. 11 depicts an alternative embodiment of a communication system according to the present application.

FIG. 12 depicts an alternative embodiment of a communication system according to the present application.

FIG. 13 depicts a system architecture for a computer system according to the present application.

### DETAILED DESCRIPTION

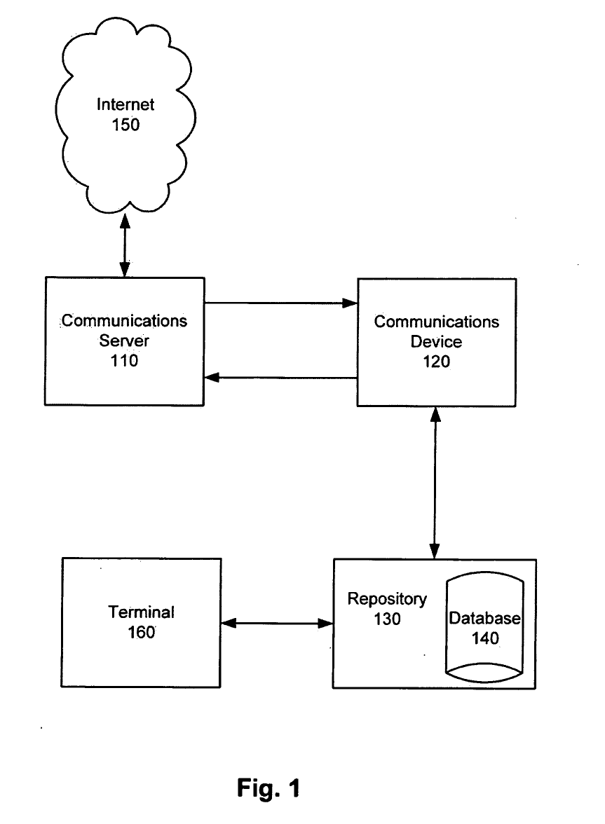

FIG. 1 depicts an embodiment of a system according to the present application. A Communications Server 110 manages the communications of a Communications Device 120. The Communications Server 110 may receive requests to route communications to the Communications Device 120 as well as handle requests from the Communications Device 120 to send communications. A Communications Server 110 may be any type of computer system supporting a communication protocol used by the Communications Device 120. The Communications Server 110 may be a computer or computer system, such as, for example, a personal computer, a distributed computing system, a mainframe, a parallel computing system, or any other type of computer system. In one or more embodiments, the Communications Sever 110 may be an email server.

A Communications Device 120 may be any computing device supporting a communication protocol. A communications device may include, but is not limited to, mobile devices, smart phones, iphones, cellular phones, Blackberry® devices, personal digital assistances (PDA), mp3 players, laptops, and computers. In an embodiment, the Communications Server 110 may function as a Communications Device 120. If the Communications Device 120 is a server, then it may communicate with the Repository 130 in the same manner as described below. Communications Server 110 may send and receive information, such as in the form of messages or communications, through a network, such as the Internet 150, a telecommunications, or data network for transmittal to the Communications Device 120. Elements of a communication system may rely on a network, such as Internet 150, to communicate with other elements of the communication system as depicted, including, but not limited to, a Communications Server 110, a Communications Device 120, a Terminal 160, a Repository 130, and a Database 140. A message may be any type of communication and will be used interchangeably throughout the present application. A message may be in any format supported by an element within the communication system. The Communications Server 110 and Communications Device 120 may utilize any communication protocol to send and receive communications, such as, for example, General Packet Radio Service (GPRS), Extensible Markup Language (XML), and Short Message Services (SMS) protocols.

Communications may have data for text, audio, video, visual images, multimedia, or any combination thereof. Communications may also have attachments, such as a file, which may be considered part of the communication. Communication file types may include, but are not limited to, word processing file types (e.g. .doc, .ps, .odt), portable document format (e.g. .pdf) files, audio, video, and/or visual file types (e.g. .mpg, .dss, .jpg, .mp3), and spreadsheet files (e.g. .xls).

The Communications Device 120 and/or the Communications Server 110 or any combination thereof may copy one or more messages or portions of a message. The Communications Device 120 and/or the Communications Server 110 may copy a message after receipt and decryption of the message or before encryption of a message by Communications Device 120, and send the one or more copied messages to a Repository 130. Alternatively, the Communications Device 120 may copy a message after receipt but before decryption of the message or after encryption of a message by Communications Device 120, and send the one or more copied messages to a Repository 130. If previously decrypted, then the message or portion of the message may be re-encrypted prior to being sent to the Repository 130. If encrypted, then the message or portion of the message may be encrypted again prior to being sent to the Repository 130. The first encryption and second encryption may be accomplished using the same encryption algorithm or different algorithms, as would the decryption. In one or more embodiments, a portion of the message may be sent to a Repository 130 as soon as the portion is encrypted for transmission to the Repository 130.

The communications between the Communications Device 120, Communications Server 120, and the Repository 130 may be out-of-band communications. Out-of-band communications may occur outside of a previously established communications method or channel. For example, the Communications Device 120 or Communications Server 110 may send and/or receive a communication on a first communication channel, such as a telecommunications network, and the Communications Device 120 or Communications Server 110 may send a communication, information on interactions of the Communications Device 120, or copy of a communication to the Repository 130 on a second communication channel, such as a private network.

The Repository provides storage for data, such as memory in a computer system. In one or more embodiments, the repository is a computer system and may function as a database server. The Repository may have any type of storage device or memory, such as, for example, magnetic disc, semiconductor (volatile and/or non-volatile), such as, EPROM, EEPROM, FLASH EEPROM, Random Access Memory (RAM), Static Random Access Memory (SRAM), Dynamic Random Access Memory (DRAM), Synchronous Dynamic Random Access Memory (SDRAM), Double Data Rate Synchronous Dynamic Random Access Memory (DDR-SDRAM), optical disc, a storage area network (SAN), or support any storage scheme, such as Redundant Array of Independent Disks (RAID). The Communications Device 120 may execute a routine to send a copy of one or more of the messages to the Repository 130 which may include or have access to a Database 140. Implementations of a database may include, but are not limited to, relational databases, object-oriented databases, a file system, or any other collection of data. The Repository may provide the ability for a third party to monitor any number of communications or messages using the communications device. For example, a member of a law enforcement agency may query a database of a Repository to monitor all messages sent and received by a communications device.

The Communications Server 110 may interrogate the Communications Device 120 to determine if communication system software is installed on the Communications Device 120. Communication system software and/or hardware may perform an interception of a message, a copy of a message, encrypt a message, decrypt a message and/or storage of the message. The installation and execution of the software on the Communications Device 120 may be unknown to the user of the device. The software may be embedded in a chip which is installed in the device during manufacture. The software may also be installed during initialization, startup, initial sign-on, device activation, or at any point during operation of the device. The Communications Server 110 may request a version number of the software installed on the Communications Device 120. If the Communications Device 120 does not have the software or the appropriate version, then the Communications Server 110 may push down the software to the Communications Device 120. Alternatively, the Communications Device 120 may pull the software from the server by requesting an update or initial download of the software.

The Communications Device 120 may be coupled to the Repository 130 through a dedicated link, a peer-to-peer network, or any other type of network. Communications may be sent and received in accordance with communication protocols that includes, but is not limited to, Transmission Control Protocol and the Internet Protocol (TCP/IP), the Simple Mail Transfer Protocol (SMTP), Internet Message Access Protocol (IMAP), Post Office Protocol (POP), Short Message Service (SMS) format, Hypertext Transfer Protocol (HTTP) format, Multimedia Messaging Service (MMS), Instant Message (IM) or any other communication protocol. The Repository 130 may store the messages in a Database 140 for subsequent retrieval. The messages may be encrypted before being stored in the Repository 130. Encryption keys for the messages may be provided at the Repository 130 or the Communications Device 120 may provide the encryption keys to the Repository 130.

The Repository 130 may be coupled to a Terminal 160, which may be a remote computing system, with a network or a dedicated link. A terminal may be any computing system that can execute a sequence of instructions. The Terminal 160 may be accessible by authorized users, such as a member of a law enforcement agency, in order to provide access to the messages stored in the Database 140. Authorized users may include, but are not limited to, a system manager, a system administrator, a third party to a message author and a message recipient, a communications device user, a remote user, or any other authorized user. The Terminal 160 provides the ability to search the messages stored in the database and view selected messages. Where the entity is a law enforcement agency, for example, the entity or a member of the entity may wish to search for messages related to an individual under surveillance or messages related to a particular incident. Members of the law enforcement agency may also want to review all messages sent to or from a particular user of a communications device.

The Repository 130 may authenticate the identity of a user and/or the Terminal 160 before granting the Terminal 160 access to the Database 140. Information that identifies an authorized user may be stored at the Repository 130. Authentication may be particularly relevant when the Terminal 160 is used to access the Repository 130 over a network, such as the Internet.

The Repository 130 provides for bidirectional communication. The Repository 130 may provide a confirmation of receipt of a message for storage and is able to send commands to an application intercepting messages at a Communications Device and/or Communications Server. Alternatively, an interface may be provided from the Repository 130 to law enforcement via an operator, an authorized user, or a process to allow for sending commands to the application. For example, an interface may allow an authorized user to turn on/off the interception of communications for a particular communications device, turn on/off capture of interactions for a communications device, check the version of interception software installed on a communications device, request a copy of logs kept on a communications device, and request communications on a memory stack of a communications device be encrypted and sent to the repository.

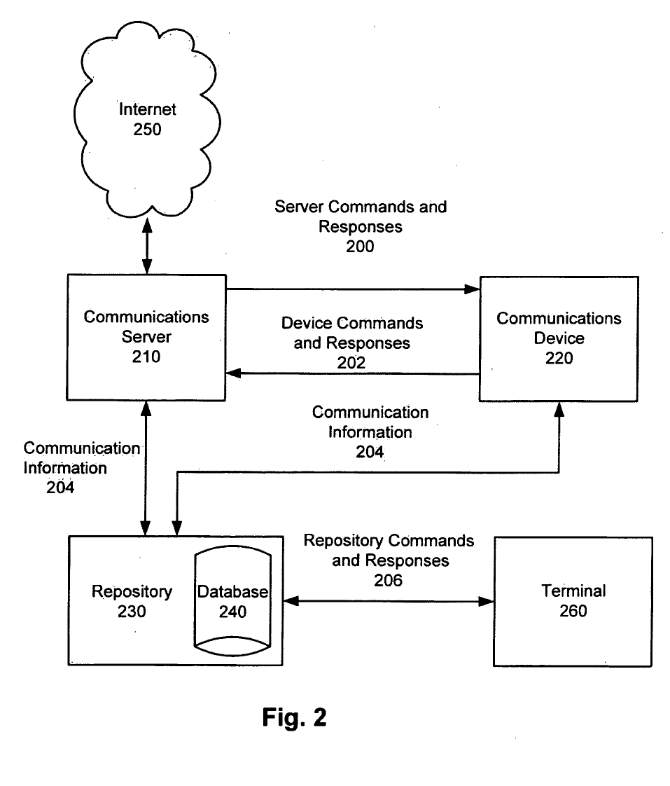

Another embodiment of the present application is depicted in FIG. 2. A Communications Server 210 manages the communications of a Communications Device 220. Communication management commands 200 may be sent to the Communications Device 220 from the Communications Server 210, such as, a request to install interception software, provision of an encryption key, a request to log interactions, a request for the interaction information, a request for information on messages received by the Communications Device 220, a request for location information, or any other communication management command, and the Communications Device 220 may respond accordingly 202. The Communications Device 220 may provide in response 202 to Communications Server 210 commands 200 such as interaction information, interaction logs, location information, a version of interception software installed or any other indicator of success or failure of a command. Communication management commands 200 may be sent from the Communications Device 220 to the Communications Server 210, such as, for example, a request to send and/or receive communications, and a request for an encryption key. In one or more embodiments, the interception software may request a Communications Server 210 or Communications Device 220 to send responses to communication management commands. Communications between the Communications Device 220 and Communications Server 210 may be out-of-band communications, such that communication is not limited to a previously established communication channel. The Communications Server 210 may be an e-mail server which receives and transmits e-mail messages from the Communications Device 220. The Communications Server 210 may send and receive communications, communication commands, and communication command responses to and from the Communications Device 220 via a network such as, for example, the Internet 250 or a another data network for transmittal to the Communications Device 220.

The Communications Server 210 may copy one or more messages sent to and/or from the Communications Device 220 and send the copied messages to a Repository 230. Communication information 204 may be sent from the Communications Server 210 and/or Communications Device 220 or any combination thereof. Communication information 204 may include an encryption key, a message, a copy of a message, an encrypted message, a twice-encrypted message, and interaction information for a communications device. Communications between the Communications Device 220, Communications Server 210, and Repository 230 may be out-of-band communications, such that communication is not limited to a previously established communication channel. Alternatively, the Communications Device 220 may execute software to send a copy of the one or more of the messages to the Repository 230. The Repository 230 has a Database 240 which stores the messages for subsequent retrieval. Messages may be encrypted before being stored in the Repository 230. Encryption keys for the messages may be installed on the repository or the Communications Server 110 may provide the encryption keys to the Repository 130. The Repository 230 may be coupled to a Terminal 260 and provide the Terminal 260 with access to the Database 240. The Terminal 360 may send Repository Commands and the Terminal may receive responses for the commands 206.

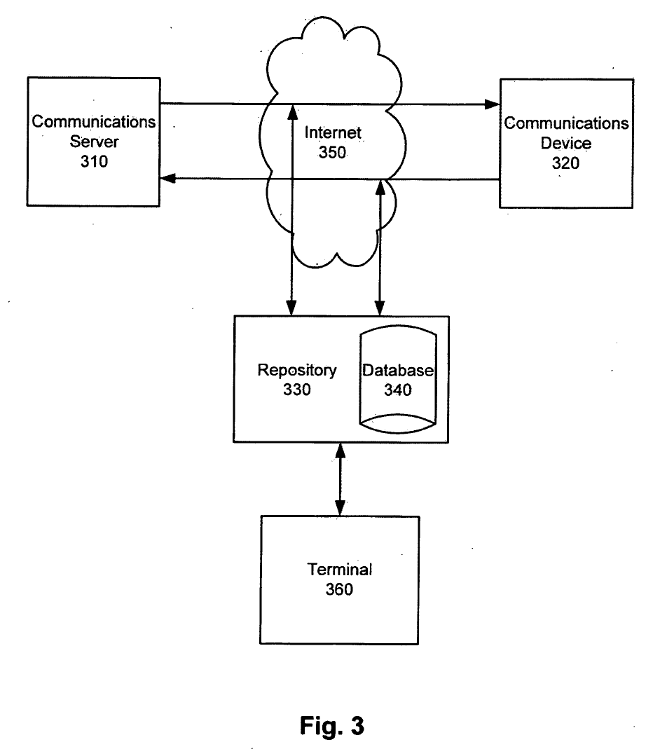

Another embodiment of the present application is depicted in FIG. 3. A Communications Server 310 manages the communications of a Communications Device 320. The Communications Server 310 may communicate with the Communications Device 320 through a network such as, for example, the Internet 350, a private network, a telecommunications network such as, for example a wireless network, or a data network. A Repository 330 may monitor at least a portion of the communications between the Communications Server 310 and the Communications Device 320 over the Internet 350, copy one or more of the communications, and store a copy of one or more communications in the Repository 330. Alternatively, or additionally, the Repository 330 may allow for monitoring of communications by a third party and/or provide for automatic analysis and/or translation of the communications. Repository 330 may be coupled to a Terminal 360 and provide the Terminal 360 with access to the Database 360. The Repository 330 may have access to encryption software and/or hardware in order to encrypt the communications prior to storing them. Encryption is a process of using an algorithm to transform a communication in order to make the communication unreadable. An encrypted communication may then be decrypted with a key and the encryption software and/or hardware. Those skilled in the art will recognize that any encryption algorithm may be used, such as, by way of example, Triple Data Encryption Standard routine (3DES) or Advanced Encryption Standard (AES). The encryption hardware/software, algorithm, and encryption key may be obtained from the Communications Server 310, Communications Device 310, Repository 330, a service provider, or any other form of communication or element of the communications system. In one or more embodiments, the encryption key and/or decryption key may be provided with the installation of any software that intercepts messages. For example, the encryption key may be hard coded in the software and/or the software may provide the ability to download the encryption key. The encryption key may be provided in the text of a message, base64 encoded in a message, or provided in any communication received by a communications device. The encryption key may be provided dynamically as part of a key exchange procedure with a receiving back-end, such as in a public key infrastructure (PKI). PKI enables computer users to be authenticated to each other, and to use the public key information in their respective public key certificates to encrypt and decrypt messages to each other. A receiving back-end may cyclically or randomly initiate a dynamic key exchange.

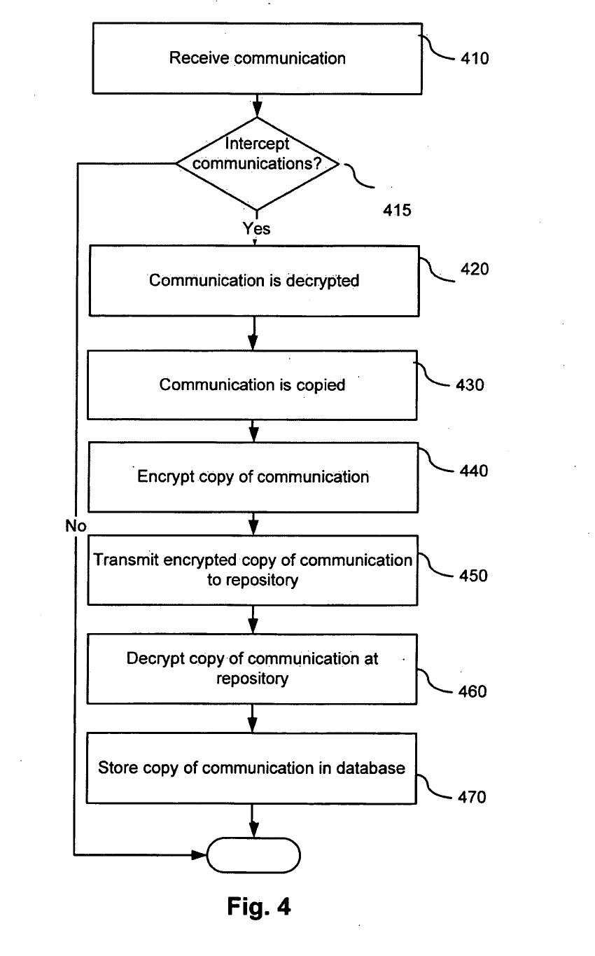

A flow diagram depicting a method according to an embodiment of the present application is shown in FIG. 4. Initially, a request may be sent for a communications device to receive a communication in accordance with a communication protocol 410. The request for a communications device to receive a communication may be from another communications device, repository, communications server or any other element within the communications system. The communications server may receive the request to route the communication to the communications device. Next, a determination may be made as to whether communications are to be intercepted 415. The determination may be made at the communications device, communications server, or any other element within the communications system. A flag may indicate that communication interception is turned on or off. If it is determined that communications are not being intercepted 415, then the received communication is not intercepted.

Continuing with FIG. 4, if the communications are to be intercepted 415, then the communications device may decrypt the communication 420 using encryption hardware and/or software. In one or more embodiments, the communications server or another element within the communications system may decrypt the communication. The communications device or communications server may create a copy of the communication 430 and encrypt the copy 440 of the communication. In one or more embodiments, a reference to a communication may be used to access the communication for encryption or decryption to create an encrypted copy of a communication or decrypted copy of a communication respectively. Any number of encryption algorithms or methods may be used to accomplish the decryption and encryption, and the same encryption algorithm and/or encryption key may not be used for each encryption or decryption of the communication. For example, a first encryption method may be used to encrypt the communication and decrypted using a first decryption method to create a decrypted communication, and a second encryption method may be used to encrypt the decrypted communication to create a re-encrypted communication and/or an encrypted copy of the communication.

The encrypted copy of the communication may then be transmitted to a repository 450. The communications device, communications server and/or the repository or any combination thereof may be used to transmit the copy of the communication to the repository. The repository may be implemented as a database server with access to a database and may service requests for the database, such as a request to store the copy. The repository may have encryption software and/or hardware to decrypt the copy of the communication 460 and store the copy in a database 470.

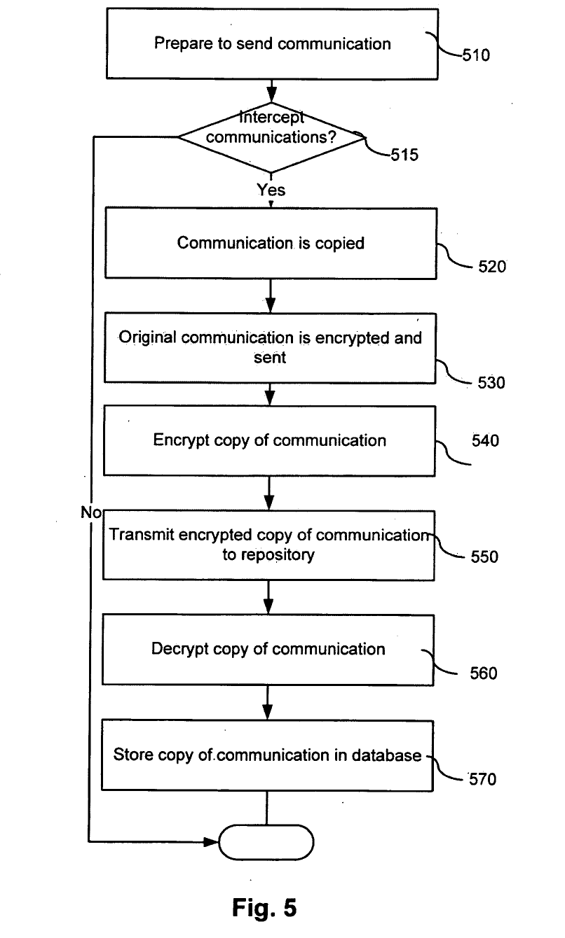

FIG. 5 depicts another method according to the present application. Initially, the communications device prepares to send a communication 510. Next, a determination is made as to whether communications are to be intercepted 515. The determination may be made at the communications device, communications server, or any other element within the communications system. If it is determined that communications are not being intercepted 515, then the received communication is not intercepted.

Continuing with FIG. 5, if the communications are to be intercepted 515, then the communications device may make a copy of the communication 520 before it is encrypted 530 and sent. Alternatively, the communications server may receive the request to encrypt and/or send the communication, and the communications server may make a copy of the communication before it is encrypted and sent. In one or more embodiments, a reference to a communication may be used to access the communication for encryption or decryption to create an encrypted copy of a communication or decrypted copy of a communication, respectively. The copy of the communication is then encrypted 540 and transmitted to the repository 550. The communications device, communications server and/or the repository or any combination thereof may be used to transmit the copy of the communication to the repository. The repository may be implemented as a database server with access to a database and may service requests for the database, such as a request to store the copy. The repository may have encryption software and/or hardware to decrypt the copy of the communication. The copy is decrypted at the repository 560 and stored in a database 570. Alternatively, the communication may be stored in its encrypted form and decrypted at a later point in time, such as when the communication is accessed. Any number of encryption algorithms or methods may be used to accomplish the decryption and encryption, and the same encryption algorithm and/or encryption key may not be used for each encryption or decryption of the communication. For example, the communication may be intercepted before a first encryption method is used and the communication is sent, and the communication may be encrypted using a second encryption method and transmitted to the repository.

The copied messages that are sent to the repository may be encrypted with an encryption algorithm separate and distinct from any encryption algorithm used by the communications device. This ensures that the communications sent to the repository may not be intercepted and decrypted by anyone who has access to the encryption methods used by the communications device. This also obviates the need for the repository to possess the ability to utilize many different encryption algorithms which may be utilized by many different portable devices or communications systems.

The system may include a software application to read out an encryption key on a portable device and transmit the encryption key to the repository for use in decryption of the communication. The software may be installed on the communications server, communications device and/or the repository or any combination thereof in order to determine an encryption key for a communications device. Alternatively or additionally, the system may include a software application that provides for the transmission of a message via an encrypted communications pathway. In one or more embodiments, metadata associated with a message is used to enable decryption of a message. Decryption of messages may be facilitated by providing both the encrypted version and the unencrypted version of one or more messages. For example, if the encryption algorithm is known, then the encryption key may be determined with the encrypted and unencrypted versions of a message. A test message may be sent to a communications device and an encrypted copy of the message may be received at repository to allow for a determination of the encryption key used for the communications device.

Alternatively, the system and method may include an intercepting box, in the form of a dedicated device, such as, for example, a memory card, buffer or storage device, or in the form of a software application, coupled between the mail server and the encrypting wireless gateway. The intercepting box intercepts the unencrypted message prior to its encryption or after it has already been decrypted. For example, the intercepting box may be a packet sniffer that intercepts traffic over a network and captures a message. This message may be stored, viewed or sent to a law enforcement agency for review.

In one embodiment, messages are filtered before they are stored in the repository's database. The filtering may be performed by the repository, the communications server, or the communications device. The filtering may be used for a plurality of purposes, such as, for example, to segregate or categorize messages containing certain terms, only certain types of messages, messages to or from a particular recipient, messages to or from a particular sender, messages sent or received on a particular date and/or time, messages sent to or received from a particular device, or messages sent or received at a particular location. The messages may be filtered based on a keyword found within the message, such as the name of a person of interest, or based on a pattern or specific keywords found in the message. In one embodiment, SMS and MMS communications are separated from other communications using a filter, and are not stored in the database or are stored in a separate database or portion of a database from other messages.

The messages stored in the repository may be accessed in a number of ways by authorized users. In one embodiment, the repository is only accessible to authorized users, such as law enforcement employees. For example, an authorized user may query the database to retrieve messages that concern a person of interest. In another embodiment, the messages stored in the repository are only accessible to the user of the communications device that sent or received the messages in the repository. Maintaining and ensuring secure access may be accomplished using known methods and/or commercially available applications, such as, for example, virtual private network (VPN).

In one embodiment, all messages sent to or from a plurality of communications devices may be stored in a single repository or one or more repositories that may service the same query. The plurality of messages may be accessible only by a network supervisor or authorized user who may further process the plurality of messages such as, for example, search the messages or organize the plurality of messages. This embodiment may be useful if a company provides portable communications devices to employees. The messages sent to and from employees using the devices may all be collected and stored for a plurality of purposes including, for example, monitoring messages or for backup purposes to prevent data loss in the case of a lost device. Those skilled in the art will recognize that there are many methods for providing backup of data.

Access to the repository may be granted in a number of ways. In one embodiment, the user of a communications device may be an authorized user of the system and have access to the repository from the device and thereby access information stored in the repository for a variety or purposes including, for example, in the event of a memory failure on the portable communications device. In another embodiment, an authorized user may access the repository through a network such as the Internet using a secure application programming interface.

In one or more embodiments, a communications device may be accessed to determine whether communication system software exists on the communications device. In one or more embodiments, software is used to determine if communication system software is installed on a communications device. For example, if the software to intercept messages is not installed, then the software may be downloaded to the communications device and installed on the communications device. Communication system software may periodically be updated on the communications device. In another embodiment, the communication system software will update automatically when a modification is made to the software. The software provisioning may be accomplished by sending an e-mail or message from the software provider with instructions to the user of a communications device on how to install or update the software. The update may be included in an SMS message. By clicking on the SMS message, the user will be provided with the capability of installing the software update, upgrade or bug fix. Updates may also be provided automatically by an operator or a communication system pushing the update to the communications device. Interactions of the user may include, for example, a key stroke, a phone call, a replacement of a SIM card, or a message. The provisioning may be affected by accessing a link in an email or a message to a web page where the software can be accessed.

In an embodiment, a communications device is monitored to determine if the communications device has the appropriate communication system software installed on the communications device. For example, the interactions of a communications device with other elements of the communication system may be analyzed to determine if the correct version and/or communication system software is installed on the communications device. A communications device may be tested to determine if the communications software is installed on the communications device. A test message may be sent to the communications device to see if the communications device performs as expected, such as a test message is copied and stored in a repository. The interactions of the communications device within the communication system may be analyzed. Analysis may be performed on interactions including, but not limited to, messages from any communications device saved in the repository, entry of a communications device into area supported by a particular network, information obtained concerning operation of the communications device, or any other behavior of the communications device within a communication system.

In another embodiment, the user of the portable communications device may control access to the device and install the software necessary to provide the functionality described herein. In this embodiment, the user may prevent remote users from accessing the device or installing software on the device. Prevention of access may be accomplished by setting specific options on the device.

In one embodiment, the geographic location of the communications device is recorded in the remote repository. This may be accomplished using a Global Positioning System (GPS) receiver located in the housing of the communications device which records the location of the communications device periodically on the communications device itself or from cell information obtained from the mobile network, which is then communicated to the remote repository. Alternatively, the remote repository may receive the geographical information directly from a source that is not coupled to the communications device and periodically records the location of the communications device using the GPS receiver in the communications device. The communications server may periodically poll the communications device to obtain the location information from the GPS receiver in the communications device and the communications server may request that the database server of the repository store the location information.

In one embodiment, the system maintains a transaction log which records interactions of a communications device with other elements of the communication system. The transaction log may record interactions between the device and any other devices, such as, for example, time of communications, status data, configuration data, and geographical location. The transaction log may then be used to determine patterns in use of the communications devices.

In one embodiment, the system maintains an interaction log which records all of a user's interactions with elements of the communication system, such as all commands entered by a user and all configuration changes made by a user. Information on interactions may be gathered by logging all key strokes on a communications device and/or interactions with other elements of a communications system. For example, the interaction log may indicate whether a user has tampered with or attempted to uninstall any software on a device. The interaction log may then be used to determine patterns in use of the communications devices. The interaction log can also be used to determine the specific actions taken by the user, including key strokes, downloads of software, photographs taken, and other actions by the user of the communications device. The interaction log is a collection of data, and may be implemented as a database, a file system, a file, or any other collection of data. The interaction log may be organized by date, user, communications device, keystroke type or any other organizational structure.

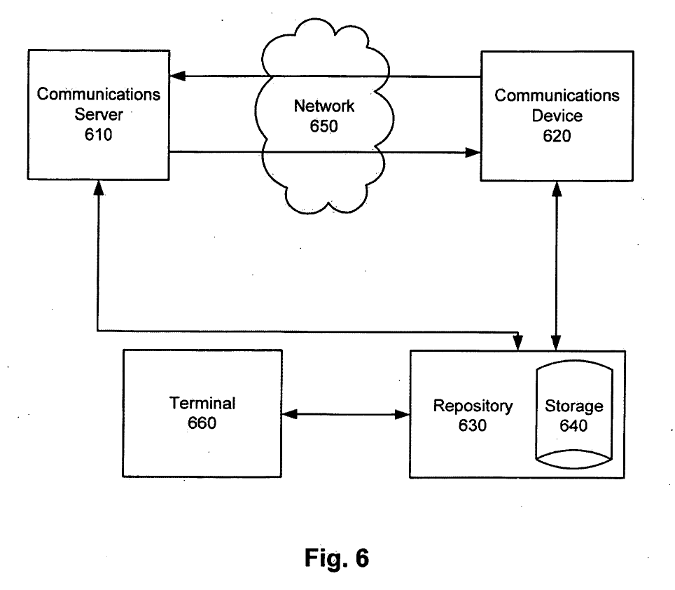

FIGS. 6-9 depict alternative embodiments of the invention. In the embodiment depicted in FIG. 6, a Communications Server 610 communicates with a Communications Device 620 through a Network 650 such as, for example, the Internet. The Communications Server 610 may receive requests to route communications to the Communications Device 620 as well as handle requests from the Communications Device 620 to send communications. A Communications Server 610 may be any type of computer system supporting a communication protocol used by the Communications Device 620. A Communications Device 620 may be any computing device supporting a communication protocol. The Communications Device 620 sends information, such as messages, to a Repository 630 which stores the information in a Storage 640 such as, for example, a database. The Communications Device 620 and Repository 630 may communicate over a private network, such as a network that uses a private IP address space. Encryption keys for the messages may be installed on the repository or the Communications Device 620 may provide the encryption keys to the Repository 630. The Repository 630 may be coupled to a Terminal 660. The Repository 630 provides the Terminal 660 with access to the Storage 640.

In one or more embodiments, interaction information for a communications device, including interactions by a user with the communications device and interactions by the communications device with elements within the communications system are logged. The keystrokes and methods executed on the communications device may be stored on the Communications Device 620, transmitted from the Communications Device 620 to a Repository 630 and/or a Communications Server 610. The Communications Server 610 may transmit the interaction information to the Repository 630. The interaction log may be stored in Storage 640, such as a database.

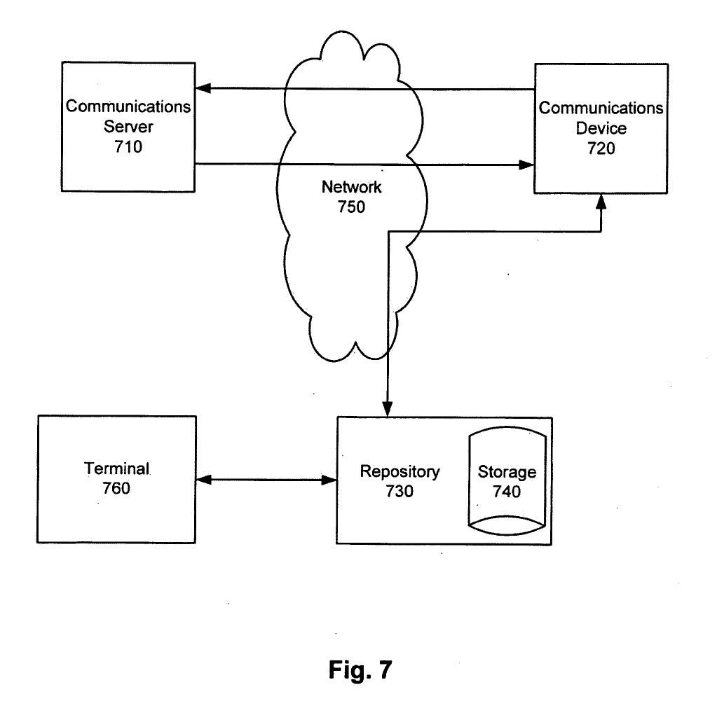

In the embodiment depicted in FIG. 7, a Communications Server 710 communicates with a Communications Device 720 through a public Network 750, such as the Internet. The Communications Server 710 may receive requests to route communications to the Communications Device 720 as well as handle requests from the Communications Device 720 to send communications. A Communications Server 710 may be any type of computer system supporting a communication protocol used by the Communications Device 720. A Communications Device 720 may be any computing device supporting a communication protocol. The Communications Device 720 also sends information, such as messages, to a Repository 730 which stores the information in a Storage 740 such as, for example, a database. Encryption keys for the messages may be installed on the repository or the Communications Device 720 may provide the encryption keys to the Repository 730. The Repository 730 may be coupled to a Terminal 760. The Repository 730 provides the Terminal 760 with access to the Storage 740.

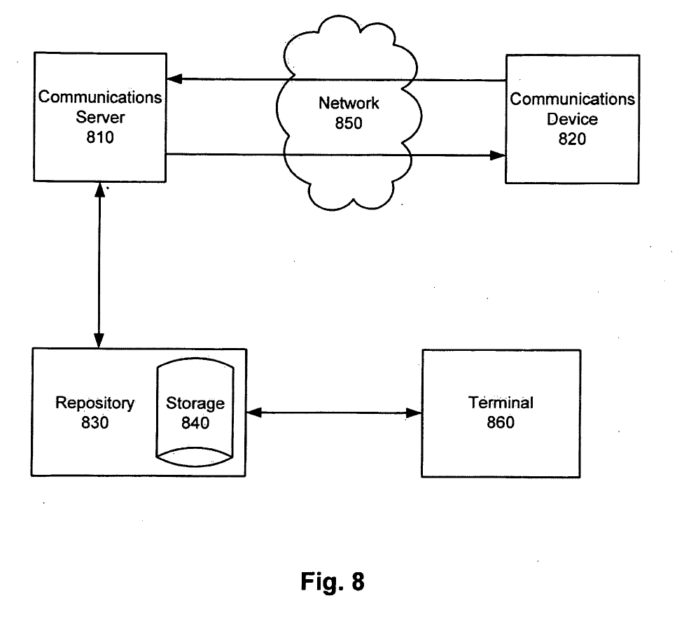

In the embodiment depicted in FIG. 8, a Communications Server 810 communicates with a Communications Device 820 through a Network 850 such as the Internet. The Communications Server 810 may receive requests to route communications to the Communications Device 820 as well as handle requests from the Communications Device 820 to send communications. A Communications Server 810 may be any type of computer system supporting a communication protocol used by the Communications Device 820. A Communications Device 820 may be any computing device supporting a communication protocol. The Communications Server 810 also sends information such as messages to a Repository 830 which stores the information in a Storage 840 such as, for example a database. The Communications Server 810 and Repository 830 may communicate over a VPN or a private network, such as a network that uses a private IP address space. Encryption keys for the messages may be installed on the repository or the Communications Server 810 may provide the encryption keys to the Repository 830. The Repository 830 may be coupled to a Terminal 860. The Repository 830 provides the Terminal 860 with access to the Storage 840.

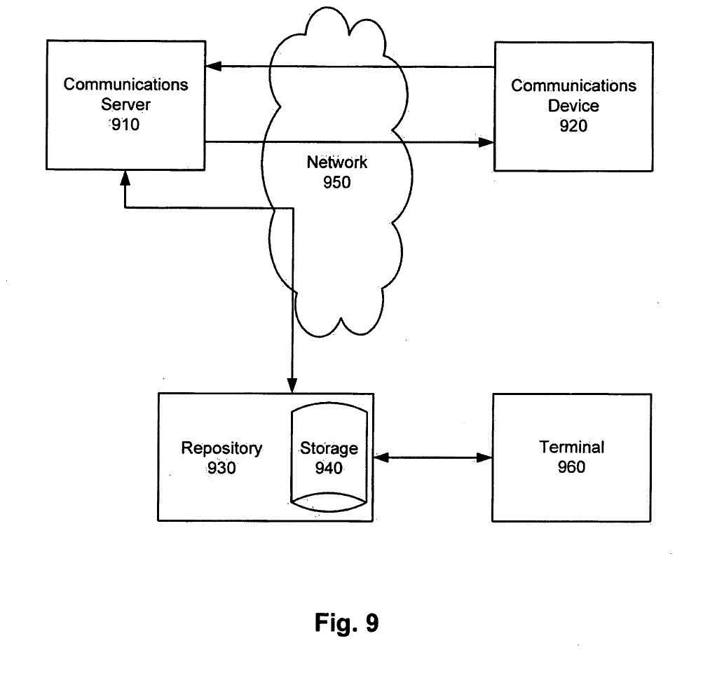

In the embodiment depicted in FIG. 9, a Communications Server 910 communicates with a Communications Device 920 through a public Network 950 such as, for example, the Internet. The Communications Server 910 may receive requests to route communications to the Communications Device 920 as well as handle requests from the Communications Device 920 to send communications. A Communications Server 910 may be any type of computer system supporting a communication protocol used by the Communications Device 920. A Communications Device 920 may be any computing device supporting a communication protocol. The Communications Server 910 also sends information such as messages to a Repository 930 over a public Network 950 which stores the information in a Storage 940 such as, for example, a database. The Repository 930 may be coupled to a Terminal 960. Encryption keys for the messages may be installed on the repository or the Communications Server 110 may provide the encryption keys to the Repository 130.

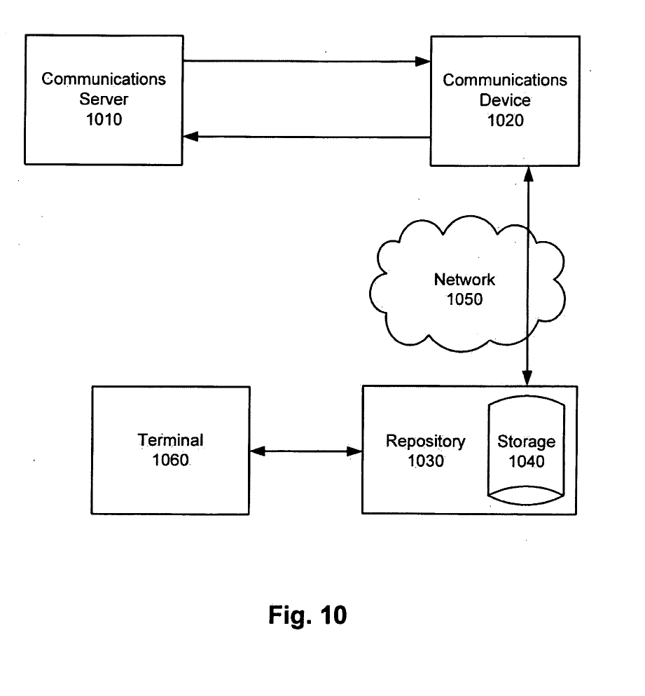

In the embodiment depicted in FIG. 10, a Communications Server 1010 communicates with a Communications Device 1020 over a private network. The Communications Device 1020 communicates with a Repository 1030 through a Network 1050 such as, for example, the Internet. The Communications Server 1010 may receive requests to route communications to the Communications Device 1020 as well as handle requests from the Communications Device 1020 to send communications. A Communications Server 1010 may be any type of computer system supporting a communication protocol used by the Communications Device 1020. A Communications Device 1020 may be any computing device supporting a communication protocol. The Repository has Storage 1040 such as, for example, a database for storing information communicated from the Communications Device 1020. The Repository 1030 may be coupled to a Terminal 1060. Encryption keys for the messages may be installed on the repository or the Communications Device 1010 may provide the encryption keys to the Repository 1030.

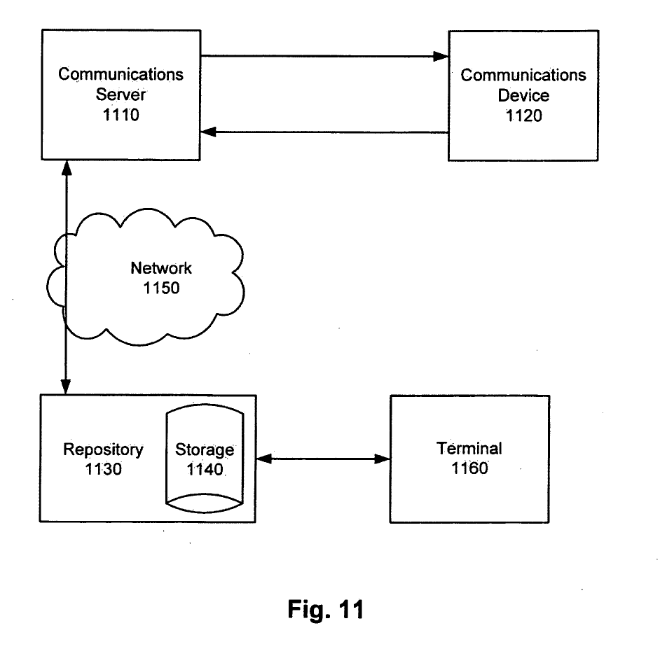

In the embodiment depicted in FIG. 11, a Communications Server 1110 communicates with a Communications Device 1120. The Communications Server 1110 may receive requests to route communications to the Communications Device 1120 as well as handle requests from the Communications Device 1120 to send communications. A Communications Server 1110 may be any type of computer system supporting a communication protocol used by the Communications Device 1120. A Communications Device 1120 may be any computing device supporting a communication protocol. The Communications Server 1110 also communicates through a Network 1150 such as, for example, the Internet, with a Repository 1130. The Repository 1130 includes a Storage 1140 which stores information received from the Communications Server 1110. The Repository 1130 is coupled to a Terminal 1160. Encryption keys for the messages may be installed on the repository or the Communications Server 1110 may provide the encryption keys to the Repository 1130.

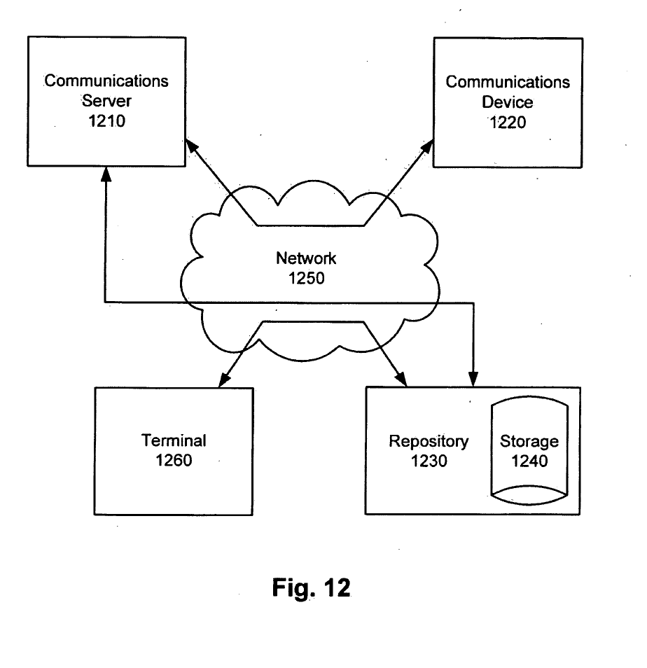

In the embodiment depicted in FIG. 12, a Communications Server 1210 communicates with a Communications Device 1220 through a Network 1250 such as, for example, the Internet. The Communications Server 1210 manages communications sent to and from the Communications Device 1250. The Communications Server communicates with a Repository 1230 through the Network 1230. The Repository stores messages that are sent to or from the Communications Device 1220 and managed by the Communications Server 1210. The messages are stored in Storage 1240. A Terminal 1260 is coupled to the Repository through the Network 1250. The Repository 1230 provides the Terminal 1260 with access to the messages in the Storage 1240. The Repository 1230 may authenticate the identity of the Terminal 1260 before providing the Terminal 1260 with access to the Storage 1240. The Terminal 1260 may be located in a remote location from the Repository 1230. Encryption keys for the messages may be installed on the repository or the Communications Server 1210 may provide the encryption keys to the Repository 1230. Users of the Terminal may access and search messages stored in the Storage 1240.

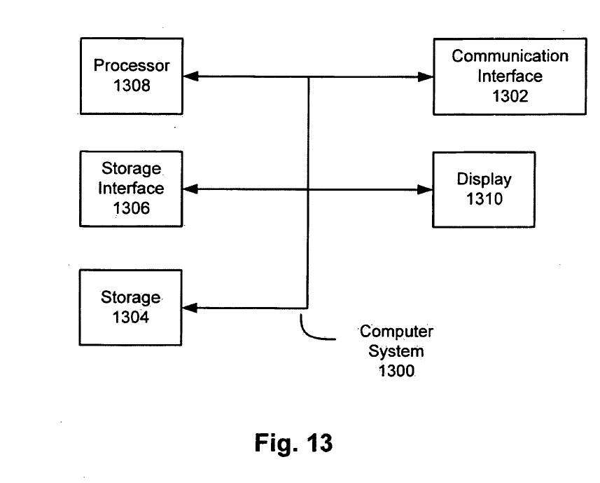

FIG. 13 depicts a system architecture for a computer system according to the present application. The execution of instructions required to practice the invention may be performed by any number of computer systems 1300 as depicted in FIG. 13. As used herein, the term computer system is broadly used to describe any computing device that can store and independently run one or more programs, applications, scripts, or software processes. Implementations may have a single computer system 1300 or any number of computer systems 1300.

Computer systems 1300 may communicate with other computer systems/devices with any number of Communication Interface(s) 1302. The Communication Interface 1302 may provide the ability to transmit and receive signals, such as electrical, electromagnetic or optical signals, that include data streams representing various types of information (e.g. messages, communications, instructions, and data). The Communication Interface 1302 may provide an implementation for a communication protocol. Instructions may be executed by the processor upon receipt and/or stored in Storage 1304 accessible to the Computer System 1300.

Storage 1304 may be accessed by the Computer System 1300 with a Storage Interface 1306. The Computer System 1300 may use the Storage Interface 1306 to communicate with the Storage 1304. The Storage Interface 1306 may include a bus coupled to the storage and able to transmit and receive signals. Storage 1304 may include random access memory (RAM) or other dynamic storage devices, for storing dynamic data and instructions executed by a Processor 1308. Any number of Processor(s) 1308 may be used to execute instructions for the Computer System 1300. Storage may include, but is not limited to, read only memory (ROM), magnetic disks, flash drives, usb drives, and optical disks. A Computer System 1300 may be connected to a Display 1310 for displaying information to a user.

“Computer usable medium” or “Computer readable medium” refers to any medium that provides information or may be used by a Processor 1308. Medium may include volatile and non-volatile storage mediums.

As these and other variations and combinations of the features discussed above can be utilized without departing from the present application as defined by the claims, the foregoing description of the preferred embodiment should be taken by way of illustration rather than by way of limitation of the invention set forth in the claims.

What is claimed is:

1. A method for a communication system, comprising:
receiving a request to route an encrypted message for a communications device, wherein the encrypted message has been encrypted using a first encryption method;
decrypting the encrypted message using a first decryption method to create a decrypted message;
re-encrypting the decrypted message using a second encryption method to create a re-encrypted message;
transmitting the re-encrypted message;
decrypting the re-encrypted message using a second decryption method to create a decrypted re-encrypted message; and
storing the decrypted re-encrypted message.

2. The method for a communication system of claim 1, further comprising:
copying the decrypted message from a memory stack before re-encrypting the decrypted message using the second encryption method.

3. The method for a communication system of claim 1, wherein the decrypted re-encrypted message is stored in a repository.

4. The method for a communication system of claim 3, wherein the repository provides for a third party to monitor at least one of messages sent by a communications device and messages received by a communications device.

5. The method for a communication system of claim 1, wherein the encrypted message is an e-mail message.

6. The method for a communication system of claim 1, wherein the encrypted message is an instant message.

7. The method for a communication system of claim 1, further comprising:
recording location information in a repository.

8. The method for a communication system of claim 3, wherein the repository filters messages.

9. The method for a communication system of claim 3, wherein the repository filters messages and stores the messages in the repository by a date.

10. The method for a communication system of claim 7, wherein the location information comprises a geographical position of the communications device.

11. The method for a communication system of claim 1, further comprising:
monitoring interactions with a communications device by a user.

12. The method for a communication system of claim 1, further comprising:
monitoring interactions of a communications device within a communication system.

13. The method for a communication system of claim 1, further comprising:
storing interactions of a communications device in an interaction log.

14. The method for a communication system of claim 1, further comprising:
transmitting interception software to a communications device.

15. The method for a communication system of claim 1, further comprising:
transmitting interception software to a communications device upon entry of the communications device into a network.

16. The method for a communication system of claim 1, further comprising:
receiving an encryption key from a communications device.

17. The method for a communication system of claim 1, further comprising:
transmitting an encryption key to a repository.

18. The method for a communication system of claim 1, further comprising:
transmitting the re-encrypted message to a repository using a first communication channel; and
transmitting information on interactions to the repository using a second communication channel.

19. The method for a communication system of claim 1, further comprising:
copying the encrypted message from a memory stack in the communications device.

20. A method for a communication system, comprising:
receiving an encrypted message at a communications device;
decrypting the encrypted message using a first decryption method to create a decrypted message;
re-encrypting the decrypted message using a second encryption method to create a re-encrypted message; and
sending the re-encrypted message for decryption and storage.

21. The method for a communication system of claim 20, further comprising:
decrypting the re-encrypted message to create a decrypted re-encrypted message; and
storing the decrypted re-encrypted message in a repository.

22. The method for a communication system of claim 20, further comprising:
sending information on interactions of the communications device.

23. The method for a communication system of claim 20, further comprising:
receiving interception software on the communications device.

24. The method for a communication system of claim 20, further comprising:
receiving interception software on the communications device upon entry of the communications device into a network.

25. The method for a communication system of claim 20, further comprising:
receiving an encryption key from a communications server.

26. A method for monitoring a communications device, comprising:
maintaining an interaction log for a communications device which records interactions within the communication system;
encrypting the interaction log using an encryption method to create an encrypted interaction log;
transmitting the encrypted interaction log to a repository;
decrypting the encrypted interaction log at the repository using a decryption method to create a decrypted interaction log; and
storing the decrypted interaction log in the repository.

27. The method for monitoring a communications device of claim 26, further comprising:
recording location information in the interaction log.

28. The method for monitoring a communications device of claim 26, wherein the location information comprises the geographical position of the communications device.

29. The method for monitoring a communications device of claim 26, wherein the encrypted interaction log is transmitted to a repository periodically.

30. The method for monitoring a communications device of claim 26 wherein the encrypted interaction log is transmitted to a remote repository periodically at a predetermined time interval.

31. A method for a communication system, comprising:
identifying at least one of a received message that has been decrypted using a first decryption method and a message to be sent that is to be encrypted using a first encryption method;
encrypting the at least one of the received message and the message to be sent using a second encryption method to create an encrypted at least one of the received message and the message to be sent;
transmitting the encrypted at least one of the received message and the message to be sent from a communications device for decryption and storage.

32. The method for a communication system of claim 31, further comprising:
storing the encrypted at least one of the received message and the message to be sent in a repository, wherein the repository provides for a third party to monitor messages sent by the communications device.

33. The method for a communication system of claim 31, further comprising:
storing the encrypted at least one of the received message and the message to be sent in a repository, wherein the repository provides for a third party to monitor messages received by the communications device.

34. The method for a communication system of claim 31, further comprising:
copying the at least one of the received message and the message to be sent from a memory stack in the communications device.

35. The method for a communication system of claim 31, further comprising:
decrypting the encrypted at least one of the received message and the message to be sent to create a decrypted re-encrypted at least one of the received message and the message to be sent; and
storing the decrypted re-encrypted at least one of the received message and the message to be sent in a repository

36. The method for a communication system of claim 31, further comprising:
copying the at least one of the received message and the message to be sent from a memory stack in the communications device.

37. A computer readable medium operable to store a set of instructions, wherein the set of instructions are configured to:
identify at least one of a received message that has been encrypted using a first decryption method and a message to be sent that has been encrypted using a first encryption method;
reencrypt the encrypted at least one of the received message and the message to be sent using a second encryption method to create a twice encrypted at least one of the received message and the message to be sent;
transmit the twice encrypted at least one of the received message and the message to be sent from the communications device for decryption and storage.

38. The method for a communication system of claim 37, further comprising:
copying the message from a memory stack in the communications device.

39. A communication system, comprising:
a server to service requests to route an encrypted message for a communications device, wherein the encrypted message has been encrypted using a first encryption method;
a computer readable medium operable to store a set of instructions, wherein the set of instructions are configured to:
decrypt the encrypted message using a first decryption method to create a decrypted message;
re-encrypt the decrypted message using a second encryption method to create a re-encrypted message;
transmit the re-encrypted message;
decrypt the re-encrypted message using a second decryption method to create a decrypted re-encrypted message; and
store the decrypted re-encrypted message

40. The communication system of claim 37, wherein the server provides software with the set of instructions for installation on a communications device.

41. The communication system of claim 37, wherein the server services a request for an installation of software with the set of instructions on a communications device.
